(19) United States
(12) Patent Application Publication
(10) Pub. No.: US 2015/0121296 A1
(43) Pub. Date: Apr. 30, 2015

(54) METHOD AND APPARATUS FOR PROCESSING AN INPUT OF ELECTRONIC DEVICE

(71) Applicant: Samsung Electronics Co., Ltd., Gyeonggi-do (KR)

(72) Inventors: Jiwoong OH, Seoul (KR); Eunyeung Lee, Gyeongsangbuk-do (KR)

(73) Assignee: Samsung Electronics Co., Ltd.

(21) Appl. No.: 14/523,304

(22) Filed: Oct. 24, 2014

(30) Foreign Application Priority Data
Oct. 31, 2013 (KR) 10-2013-0131322

(51) Int. Cl. G06F 3/0482; G06F 3/0484; G06F 3/0488; G06F 3/041

(52) U.S. Cl. CPC G06F 3/0482; G06F 3/0416; G06F 3/04845; G06F 3/04883
USPC 715/783; 345/173

(57) ABSTRACT

A method and an apparatus for processing an input of an electronic device are provided. The method includes displaying an object screen; buffering an object at a position where a proximity input is detected, when the proximity input is detected; and, executing the buffered object collectively and displaying an execution screen when a touch input is detected on the object on which the proximity input occurs.

### PRIORITY

This application claims priority under 35 U.S.C. §119(a) to a Korean Patent Application filed on Oct. 31, 2013 in the Korean Intellectual Property Office and assigned Serial No. 10-2013-0131322, the entire contents of which are incorporated herein by reference.

### BACKGROUND

1. Field of the Invention

The present invention relates generally to a method and an apparatus for processing an input of an electronic device having a touch device and more particularly, to a method and an apparatus for continuously and/or discontinuously selecting only a desired object by minimizing a repeat of unnecessary operations.

2. Description of the Related Art

With the development of digital technology, use of various electronic devices capable of performing communication and processing personal information, for example, a mobile communication terminal, a smart phone, a tablet Personal Computer (PC), and the like, has been currently popularized. An electronic device provides various functions such as a call function, a word processor, an E-mail editing function, a media reproduction function, a scheduling function, an Internet function, a Social Networking Service (SNS) function, an address function, and the like.

As an electronic device supports various functions, a method of rapidly and conveniently controlling the electronic device is required. As use of an electronic device having a touch screen increases, it has become possible to easily and intuitively control an electronic device by using a touch interaction.

In addition, an electronic device supports a function of recognizing an approaching object depending on a detected signal when the approaching object is detected in a non-touched scheme although a screen is not touched by using a touch panel capable of detecting a hovering. In this case, the non-touched scheme may involve a proximity input, for example, a hovering, via an input means, for example, a user's finger, an electronic pen, and the like. In the electronic device, a pointer is detected at a region on the touch screen via the proximity input, so as to elect, execute, and preview an object.

However, in order to select a plurality of unspecified objects from a plurality of objects displayed on the electronic device, a behavior may result in which inputs are repeated through a certain key. For example, a web page connected to a selected link item is executed on a web page screen, and a web page connected to another selected link item may be selected and executed after a user returns to an initial web page in order to view another web page. In the process of repeating this operation several times, it is difficult for the user to quickly access a desired function.

### SUMMARY

The present invention has been made to address the above-mentioned problems and disadvantages and to provide at least the advantages described below. Accordingly, an aspect of the present invention provides a method and an apparatus for continuously and/or discontinuously selecting only a desired object by minimizing a repeat of unnecessary operations. The present invention supports a selection and an execution of an object via a proximity input, for example, hovering, to buffer the object in a buffer and collectively execute the buffered object through a touch input. Another aspect of the present invention provides an electronic device for performing a necessary operation without the conventional repeat process of the multiple selection and/or execution, where the electronic device provides an input method of organically connecting the proximity input and the touch input, so that the user can easily and rapidly input and execute continuous/discontinuous input/selection.

In accordance with an aspect of the present invention, there is provided a method of processing an input of an electronic device. The method includes displaying an object screen; buffering an object at a position where a proximity input is detected, when the proximity input is detected; and executing the buffered object collectively and displaying an execution screen when a touch input is detected on the object on which the proximity input occurs.

In accordance with another aspect of the present invention, there is provided a method of processing an input of an electronic device. The method includes displaying an object screen; buffering an object at a position where a proximity input is detected when the proximity input is detected, and displaying the object in a preview form by applying an effect to the object; and displaying the object after the effect applied to the object is released when a touch input is detected on the object on which the proximity input is detected.

In accordance with another aspect of the present invention, there is provided an apparatus for processing an input of an electronic device. The apparatus includes a touch screen configured to display an object screen and detect a proximity input and a touch input; a buffer configured to buffer an object selected by the proximity input; and a controller configured to buffer an object, at a position where a proximity input is detected, in the buffer when the proximity input is detected on the object screen displayed on the touch screen, execute the buffered object collectively when a touch input is detected on the object where the proximity input is detected, and display the object execution screen.

In accordance with another aspect of the present invention, there is provided an apparatus for processing an input of an electronic device. The apparatus includes a touch screen configured to display an object screen and detect a proximity input and a touch input; a buffer configured to buffer an object selected by the proximity input; and a controller configured to buffer an object, located at a position where the proximity input is detected, in the buffer and display the object in a preview form by applying an effect to the object, and release the effect applied to the object and display the object when the touch input is detected on the object where the proximity input is detected.

### BRIEF DESCRIPTION OF THE DRAWINGS

The above and other aspects, features, and advantages of the present invention will be more apparent from the following detailed description, taken in conjunction with the accompanying drawings, in which:

FIG. 1 is a block diagram of an electronic device having a touch device;

FIG. 2 is a flowchart of a method of processing a proximity input;

FIG. 3 is a flowchart of a method of displaying a buffered object;

FIGS. 4A, 4B and 4C illustrate of processing a proximity input;

FIG. 5 is a flowchart of a method of processing a proximity input; and

FIGS. 6A and 6B are illustrations of processing a proximity input.

### DETAILED DESCRIPTION OF EMBODIMENTS OF THE PRESENT INVENTION

Hereinafter, embodiments of the present invention are described in detail with reference to the accompanying drawings. It should be noted that the same elements are designated by the same reference numerals although they are shown in different drawings. Further, a detailed description of a known function and configuration which may make the subject matter of the present invention unclear is omitted. Hereinafter, it should be noted that only descriptions that facilitate understanding of the embodiments of the present invention are provided, and other descriptions are omitted to avoid obfuscating the subject matter of the present invention.

Meanwhile, embodiments of the present invention shown and described in this specification and the drawings correspond to examples presented in order to explain technical contents of the present invention, and to facilitate comprehension of the present invention, but are not intended to limit the scope of the present invention. It will be apparent to those having ordinary knowledge in the technical field, to which the present invention pertains, that it is possible to practice other modified embodiments based on the technical idea of the present invention as well as the embodiments disclosed herein.

An electronic device according to an embodiment of the present invention may be a mobile communication terminal, a smart phone, a tablet Personal Computer (PC), a hand-held PC, a Portable Multimedia Player (PMP), a Personal Digital Assistant (PDA), a notebook PC or the like.

According to an embodiment of the present invention, an object selected through the proximity input may be stored in a buffer. The object may be buffered in the buffer according to the selected object, for example, a photograph, a file, an application, an icon, and the buffered object may be collectively executed when a touch is input. Alternatively, the object may be buffered in the buffer according to the selected object, for example, a key pad, and the buffered object may be immediately displayed on a display unit in a preview manner. The object stored in the buffer may be deleted and initialized after the objects are collectively processed through the touch input or when a proximity input is not maintained.

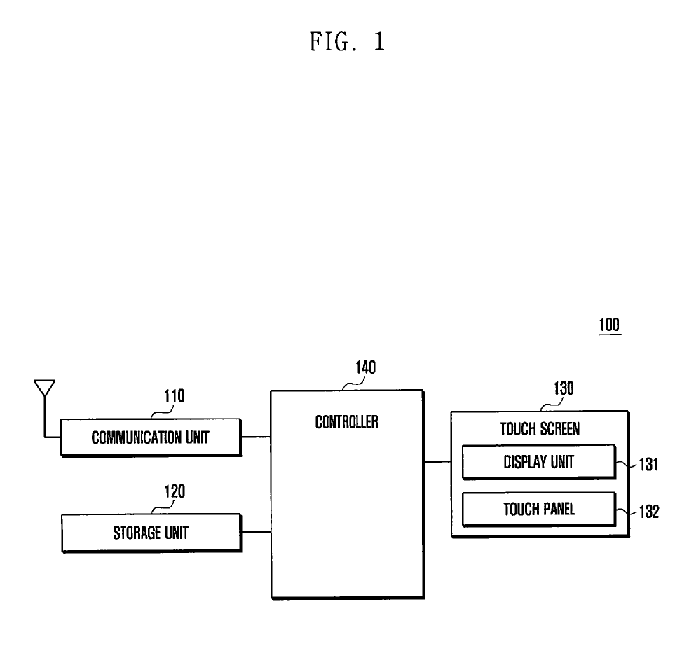

FIG. 1 is a block diagram of an electronic device 100 having a touch device.

Referring to FIG. 1, the electronic device 100 of the present invention includes a communication unit 110, a storage unit 120, a touch screen 130, and a controller 140.

The communication unit 110 performs a voice call, a video call, or data communication with an external device via a network. The communication unit 110 may be configured with a Radio Frequency (RF) transmitter that upward-converts and amplifies a frequency of a signal to be transmitted, and an RF receiver that low-noise amplifies a received signal and downward-converts a frequency of the received signal. Furthermore, the communication unit 110 may be configured with a modulator and a demodulator (e.g. a modem). The modulator and the demodulator may include a Code Division Multiple Access (CDMA) module, a Wideband CDMA (WCDMA) module, an Long Term Evolution (LTE) module, a Wireless Fidelity (Wi-Fi) module, a Wireless Broadband (WiBro) module, a Bluetooth module, a Near Field Communication (NFC) module, and the like. The communication unit 110 may be a mobile communication module, an Internet communication module, and/or a short-range communication module.

The storage unit 120 includes a program memory for storing an operating program of the electronic device 100, and a data memory for storing data generated during an execution of the program.

In an embodiment of the present invention, the storage unit 120 stores the object selected by the proximity input.

The touch screen 130 is configured to include a display unit 131 and a touch panel 132, which are integrated with each other. The display unit 131 displays various screens according to the use of the electronic device 100 under control of the controller 140. The display unit 131 may include a Liquid Crystal Display (LCD) unit, an Organic Light Emitted Diode (OLED) unit, an Active Matrix Organic Light Emitted Diode (AMOLED) unit, and the like. The touch panel 132 may be a complex touch panel which includes a hand touch panel for detecting a hand gesture and a pen touch panel for detecting a pen gesture.

In an embodiment of the present invention, the display unit 131 may display an object screen under control of the controller 140. When the proximity input, e.g., hovering, is detected through the touch panel 132 on the object displayed on the display unit 131, the proximity input signal is transferred to the controller 140. The display unit 131 displays a proximity pointer at a position where the proximity input occurs, under control of the controller 140. When a touch input is detected on the object where the proximity input occurs, the display unit 131 displays the objects stored in the storage unit 120 on a screen under control of the controller 140.

The controller 140 is configured to control an overall operation of the electronic device 100, control signal flow between internal elements of the electronic device 100, perform data processing, and control a supply of electric power from a battery to the internal elements.

In an embodiment of the present invention, the controller 140 is configured to control the display unit 131 to display an object screen. Further, when the proximity input is detected on the object screen displayed on the display unit 131, the controller 140 is configured to buffer the selected object in the buffer. Furthermore, when the touch input is detected on the object, the controller 140 is configured to control the display unit 131 to display the buffered object. Moreover, when the proximity input is not detected (for example, while the proximity input is detected as a user's finger is located on the screen, the user moves his/her finger to an outside of the screen, or raises his/her finger until the proximity input is not detected), the controller 140 is configured to initialize the buffer so as to delete object information buffered by a previous proximity input.

The electronic device 100 selectively includes structural elements having an additional function, such as a Global Positioning System (GPS) module for receiving positioning information, an audio processing unit including a microphone and a speaker, an input unit for supporting an input based on a hard key, and the like, but the description and illustration thereof are omitted.

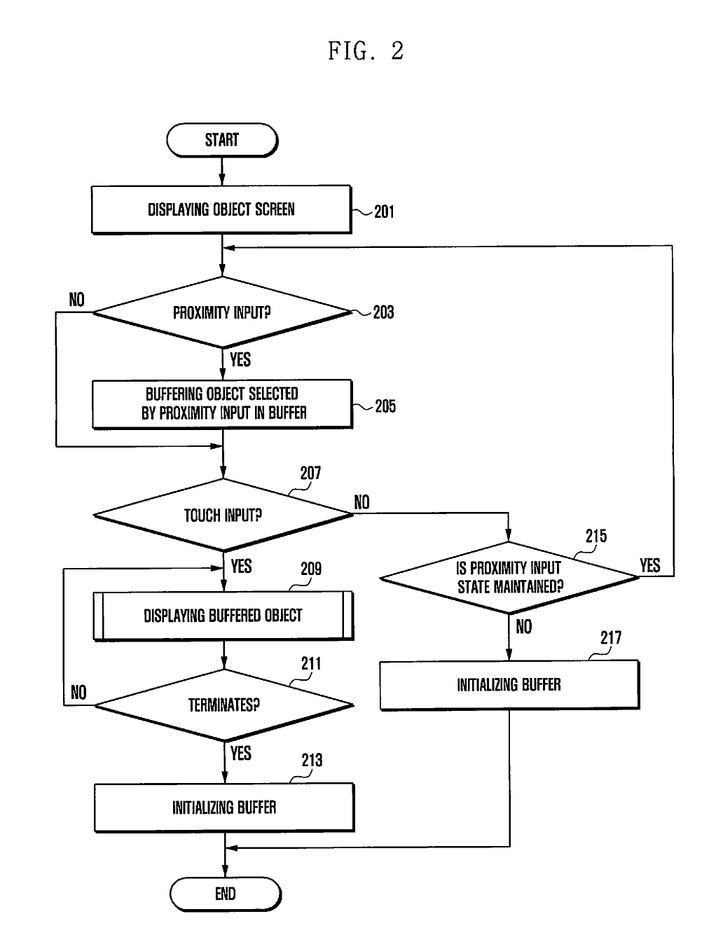

FIG. 2 is a flowchart of a method of processing a proximity input.

Referring to FIG. 2, the controller 140 is configured to control the display unit 131 to display the object screen in step 201. In this case, the object screen is a screen for an executed application, and may be an execution screen of an application such as a music player, a video player, a document or E-book reader, an Internet browser, a map, and the like. The object screen, according to the execution of the application, may be displayed and may include an icon, a thumbnail, a list item, a menu item, a text item, a link item, and the like. In an embodiment of the present invention, when the object, e.g., a text, an image, a video, and the like, is selected on the object screen, the selected object is stored in the buffer.

The controller 140 is configured to determine whether the proximity input is detected via the touch panel 132 on the object screen in step 203. Here, the proximity input may include a hovering input which means a status in which an input instrument, e.g., a user's finger, an electronic pen, does not touch the touch screen 130 and is spaced at a predetermined distance from the touch screen 130, e.g., enters within a height from a surface of the touch screen 130. For example, the input instrument, e.g., the user's finger and the electronic pen, is located at a position spaced at a distance of approximately 1 cm to 2 cm from the touch screen.

When the proximity input is detected, the controller. 140 is configured to provide a visual effect, e.g., brightness, color and magnitude, an audible effect, e.g., voice, and a tactile effect, e.g., vibration, in response to the proximity input. Further, when the input instrument is maintained for a predetermined time in the state where it is spaced at the preset distance from the touch screen, the controller 140 is configured to determine the proximity status and detect a positioning coordinate of the input instrument. In an embodiment of the present invention, the input instrument is described assuming that it is the user's finger, but the input instrument is not limited thereto.

When the proximity input is detected, the controller 140 is configured to detect the coordinate at a position where the proximity input is detected. In this case, the controller 140 is configured to determine that the object located at the coordinate is selected, and store the selected object in the buffer in step 205. In an embodiment of the present invention, when the proximity input is detected, the buffer stores the object at the position where the proximity input is detected. When the touch input occurs on the object on which the proximity input is detected, the controller 140 is configured to execute and display the object. When the touch input does not occur and the proximity input is not maintained on the object on which the proximity input is detected, the controller 140 is configured to initialize the object stored in the buffer. Particularly, when the user moves his/her finger to the outside of the touch screen 130 or raises his/her finger until the proximity input is no longer detected, then the proximity input is detected as the user's finger is subsequently located over the touch screen 130, the controller 140 is configured to initialize the buffer and delete the object information buffered by the previous proximity input.

Further, a step 203 of detecting the proximity input and a step 205 of storing the selected object in the buffer in accordance with a proximity input may be repeatedly performed when a touch input does not occur in step 207 and the proximity input is maintained in step 215. That is, the controller 140 is configured to select and store a plurality of objects which are continuously and/or discontinuously arranged and constitute an identical screen. In this case, the controller 140 is configured to sequentially store the plurality of objects, which are selected by the proximity input, in the buffer.

The controller 140 is configured to determine whether a touch input is detected on the object selected by the proximity input, in step 207. When the touch input is detected, the controller 140 is configured to collectively cause the execution of all objects buffered in the buffer and control the display unit 131 to display the executed screen in step 209. In this case, the object buffered in the buffer may include an icon, a thumbnail, a list item, a menu item, a text item, a link item, and the like, which are displayed during the execution of the application. Further, the buffered object may be at least two objects, and a window on which the object is executed may be divided on the screen of the electronic device 100 into as many windows as the number of objects buffered in the buffer, and displayed in the form of multi-windows.

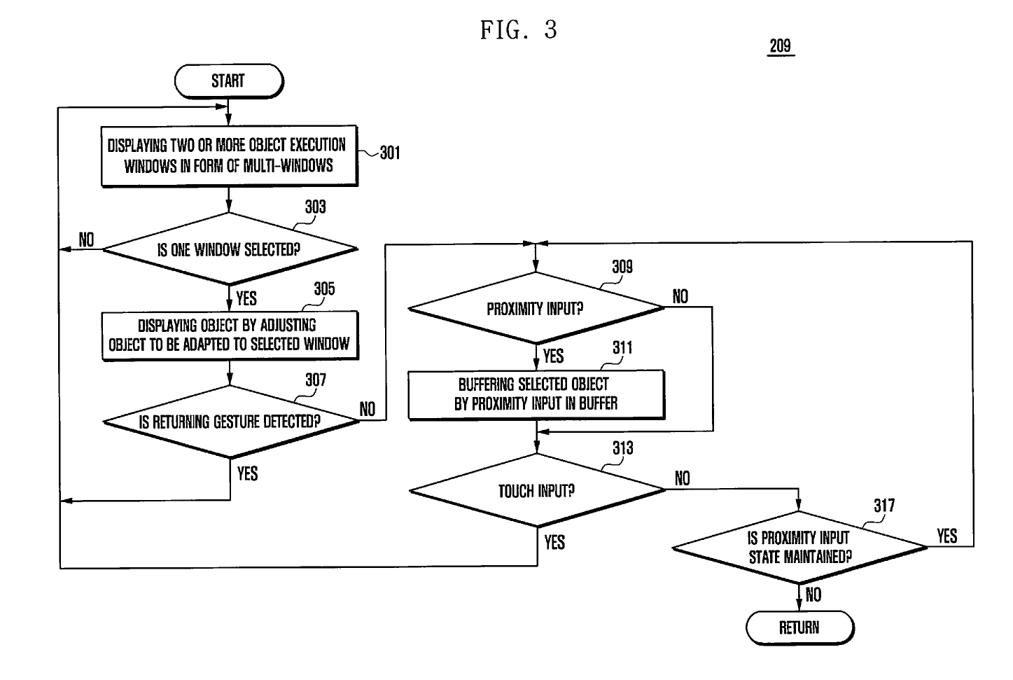

Step 209 of FIG. 2 is described below in detail with reference to FIG. 3.

FIG. 3 is a flowchart of a method of displaying a buffered object.

Referring to FIG. 3, the controller 140 is configured to control the display unit 131 to display a screen divided into at least two windows in the form of the multi-windows in step 301. On the screen having multi-windows, the controller 140 is configured to determine whether a gesture selecting one window is detected in step 303. In this case, the gesture may include at least one of a touch gesture or a drag gesture adjusting a magnitude by dragging a boundary between the windows in an expand item included in the window.

When a gesture to select one window occurs, the controller 140 is configured to cause the expansion and display of the selected window to be adapted to the size of the screen in step 305. The user may operate the expanded screen and the objects constituting the expanded screen. In this case, it may be recognized that a plurality of windows is deleted from the buffer as the screen is newly displayed as one expanded screen. However, the plurality of windows is buffered and maintained. Since the windows are buffered, the reduced window expands, and the expanded window may be enabled to be displayed in the form of multi-windows again.

The controller 140 is configured to determine whether the returning gesture is detected in step 307. The returning gesture may be a gesture for returning the expanded window to an initial status. In this case, the returning gesture may include at least one of a touch gesture or a drag gesture adjusting a magnitude by dragging a boundary between the windows in a returning item separately included in the window. When the returning gesture is detected, the controller 140 is configured to proceed to step 301 to display the screen in the form of multi-windows. If another proximity input is not detected, the buffered object constituting the multi-windows may not be initialized and may be continuously maintained.

If the returning gesture is not detected in step 307, the controller 140 is configured to determine whether the proximity input is detected via the touch panel 132 on the expanded screen in step 309. When the input instrument is maintained for a predetermined time at a preset distance from the touch screen, the controller 140 is configured to determine that the input instrument is in the proximity state.

When the proximity input is detected, the controller 140 is configured to detect the coordinate where the proximity input is detected. In this case, the controller 140 is configured to determine that the object located at the detected coordinate is selected by the proximity input. Further, the controller 140 is configured to store the selected object in the buffer, and delete the existing buffered object in step 311. Further, when a touch input occurs on the object on which the proximity input is detected, the object is executed and displayed. When the touch input does not occur on the object on which the proximity input is detected and the proximity input is not maintained, the object stored in the buffer is initialized. As described above, when the user moves his/her finger to the outside of the touch screen 130 or raises his/her finger until the proximity input is not detected while the proximity input is detected as the user's finger is located over the touch screen 130, it is determined that the proximity input is not maintained, and the controller 140 is configured to initialize the buffer and delete the object information buffered by the previous proximity input.

If the touch input is not detected in step 313 and the proximity input is maintained in step 317 as described below, the controller 140 is configured to repeatedly perform a step of detecting the proximity input, in step 309, and a step of buffering the object selected by the proximity input in the buffer, in step 311. That is, the controller 140 may store a plurality of objects in the buffer via the repeat step of selecting and storing the plurality of objects which are continuously and/or discontinuously arranged and constitute one screen.

Next, the controller 140 is configured to determine whether the touch input is detected on the object selected by the proximity input in step 313. When the touch input is detected, the controller 140 is configured to detect the touch input in step 313, and proceed to step 301 to control the display unit 131 to display a screen divided into at least two windows in the form of the multi-windows in step 301. The object buffered in the buffer may include an icon, a thumbnail, a list item, a menu item, a text item, a link item, and the like, which are displayed on an expanded screen selected from screens displayed in the form of multi-windows. In this case, at least two objects may be buffered in the buffer, and a window on which the object is executed may be divided on the screen of the electronic device 100 into as many windows as the number of objects buffered in the buffer, and displayed in the form of multi-windows.

If the touch input is not detected in step 313, the controller 140 is configured to determine whether the proximity input is maintained in step 317. When a proximity input signal is received from the touch panel 132, the controller 140 is configured to determine that the proximity input state is maintained. Alternatively, if the proximity input signal is not received from the touch panel 132, the controller 140 is configured to determine that the proximity input state is not maintained. When it is determined that the proximity input is maintained, the controller 140 is configured to proceed to step 309, and determine whether the proximity input is detected on the one expanded screen.

Referring to FIG. 2, the controller 140 is configured to determine whether the display of the buffered object is terminated in step 211. When an input of the termination occurs, the controller 140 is configured to initialize the buffer and terminate a function of the proximity input in step 213.

If the touch input is not detected in step 207, the controller 140 is configured to determine whether the proximity input is maintained in step 215. When the proximity input signal is received from the touch panel 132, the controller 140 is configured to determine that the proximity input state is maintained. If the proximity input signal is not received from the touch panel 132, the controller is configured to determine that the proximity input state is not maintained. When it is determined that the proximity input state is maintained, the controller 140 is configured to proceed to step 203, and determine whether the proximity input is detected. When it is determined that the proximity input state is not maintained, the controller 140 is configured to initialize the buffer in step 217 and terminate the proximity input function.

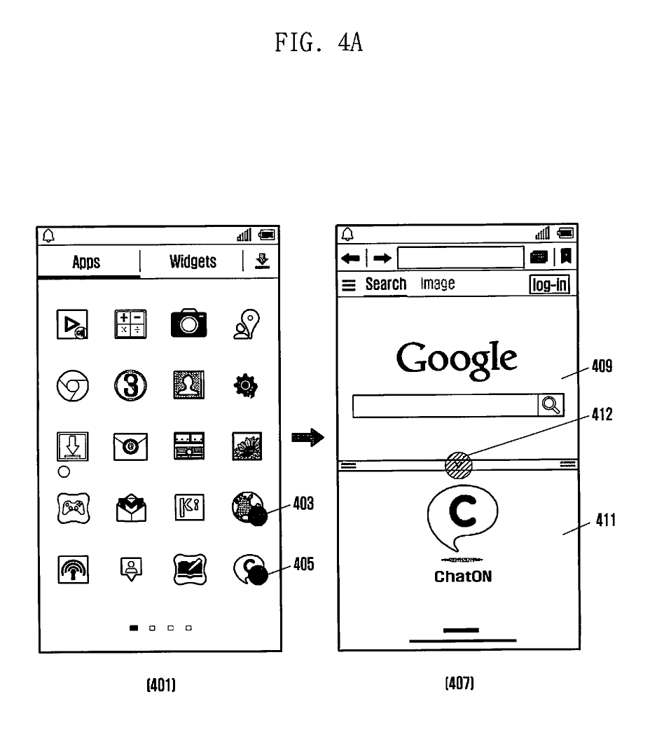

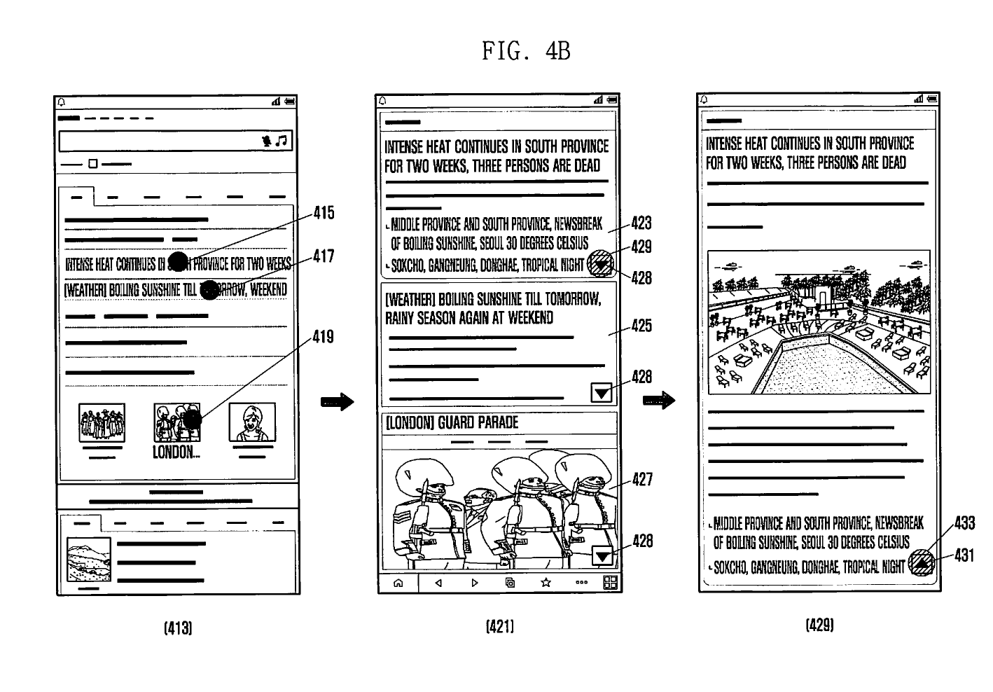

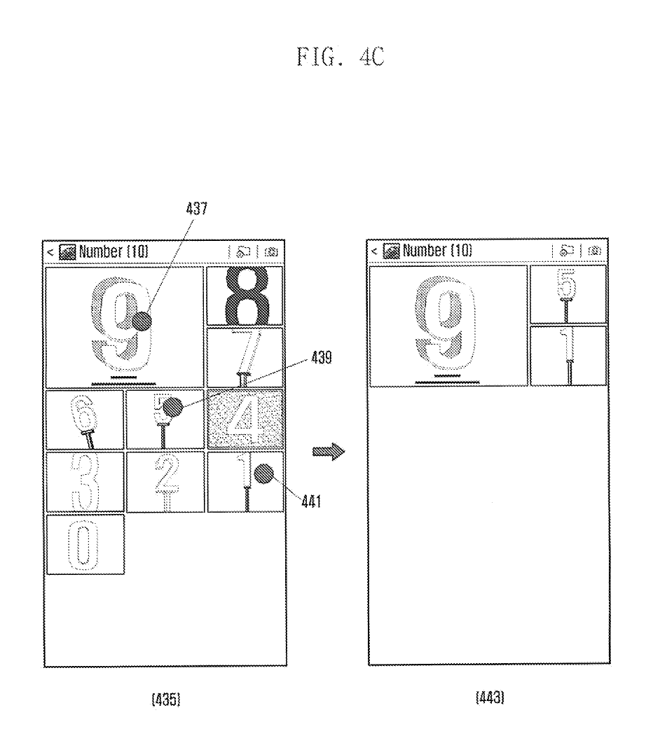

The method of FIGS. 2 and 3 are described in detail below with reference to FIGS. 4A, 4B and 4C.

FIGS. 4A, 4B, and 4C illustrate of processing the proximity input.

Referring to FIGS. 4A, 4B, and 4C, on an application 401 of FIG. 4A, the controller 140 is configured to detect a proximity input of the user on an Internet application 403 through the touch panel 132. The proximity input may include a hovering input, and it may be determined that the proximity input is detected when the input instrument, e.g., a user's finger or an electronic pen, comes close to the touch screen 130, e.g., spaced at a desired height from the touch screen 130, and is maintained for a predetermined time. When the proximity input is detected, the controller 140 is configured to store the Internet application, which is an object corresponding to a position where the proximity input occurs, in the buffer. Then, the controller 140 is configured to detect the proximity input of the user on a ChatOn application 405. As described above, when it is determined that the proximity input is detected on the ChatOn application 405 according to a hovering determination condition, e.g., a proximal distance between the input instrument and the touch screen 130 and the maintenance of the distance for the predetermined time, the controller 140 is configured to store the ChatOn application 405 in the buffer. That is, the Internet application 403 and the ChatOn application 405 may be sequentially stored in the buffer. When the proximity input is detected and the touch input occurs on the ChatOn application 405 (the position where the proximity input occurs), the controller 140 is configured to collectively execute the Internet application 403 and the ChatOn application 405, which are buffered. For example, one screen 407 in FIG. 4A may be divided into two windows, i.e., an Internet application executing window 409 and a ChatOn application executing window 411, and displayed in the form of multi-windows. Further, a size of the window may be adjusted through the drag gesture on a boundary 412 between the windows. When the touch input does not occur and the proximity input is not maintained, the object buffered in the buffer, i.e., the Internet application 409 and the ChatOn application 411, are deleted.

In another embodiment of the present invention, on an Internet application executing screen 413 of FIG. 4B, the controller 140 is configured to detect the proximity input of the user through the touch panel 132 on an Internet news link item 415. When the proximity input is detected, the controller 140 is configured to store the Internet news link item 415 in the buffer. In turn, the controller 140 is configured to detect the proximity input of the user through the touch panel 132 on the Internet news link item 417. When the proximity input is detected, the controller 140 is configured to store the Internet news link item 417 in the buffer. Then, the controller 140 is configured to detect the proximity input of the user through the touch panel 132 on an image link item 419. When the proximity input is detected, the controller 140 is configured to store the image link item 419 in the buffer. That is, the Internet news link items 415, 417, and the image link item 419 may be sequentially stored in the buffer. When the touch input occurs on the image link item 419, i.e., the item on which the proximity input is detected, in a state that the proximity input is detected, the controller 140 is configured to divide one screen into three windows, e.g., a window 423 in which the Internet news link item 415 is executed, a window 425 in which the Internet news link item 417 is executed, and a window 427 in which the image link item 419 is executed, in the form of the multi-windows, as shown in screen 421 of FIG. 4B. The windows 423, 425 and 427 displayed on the screen 421 may have a separate “expansion” item 428. When the touch input occurs on the “expansion” item 428 in the screen 429, the controller 140 is configured to display the window 423 to be suitable for a screen size 429 of the display unit 131 of the electronic device 100. Particularly, one window is displayed on a whole screen of the display unit 131 of the electronic device 100, while two remaining windows are hidden behind the window. Accordingly, the objects (i.e., Internet news link item 415, Internet new link item 417, and image link item 419) are buffered in the buffer. Further, the expanded window 429 may have a separate “returning” item 431. When the touch input 433 occurs on the “returning” item 431, the expanded window 429 may return to the screen 421 on which three divided multi-windows are displayed.

In another embodiment of the present invention, in FIG. 4C, a screen 435, on which a photograph application is executed, displays photographs randomly arranged. Then, the controller 140 is configured to detect a proximity input 437 of the user through the touch panel 132 on a “9” photograph. When the proximity input 437 is detected, the controller 140 is configured to store the photograph in the buffer. Then, the controller 140 is configured to detect the proximity input 439 of the user through the touch panel 132 on a “5” photograph. When the proximity input 439 is detected, the controller 140 is configured to store the photograph in the buffer. Then, the controller 140 is configured to detect the proximity input 441 of the user through the touch panel 132 on a “1” photograph. When the proximity input 441 is detected, the controller 140 is configured to store the photograph in the buffer. When the touch input 441 occurs on the photograph, i.e., an item on which the proximity input is detected, in the state that the proximity input 441 is detected, the controller 140 is configured to sequentially display the “9”, “5”, and “1” photographs, which are the objects buffered and selected by the proximity inputs 437, 439, and 441 like in the screen 443. That is, a photograph which the user wants to see is selected by the proximity input from many photographs stored in the electronic device 100, and the selected photograph is stored in the buffer. As the touch input is detected, only the photograph stored in the buffer is separately displayed, so that the user can easily see the desired photograph.

As a result, the objects continuously and/or discontinuously selected by the proximity input are collectively executed through the touch input, thereby minimizing the repeated operation.

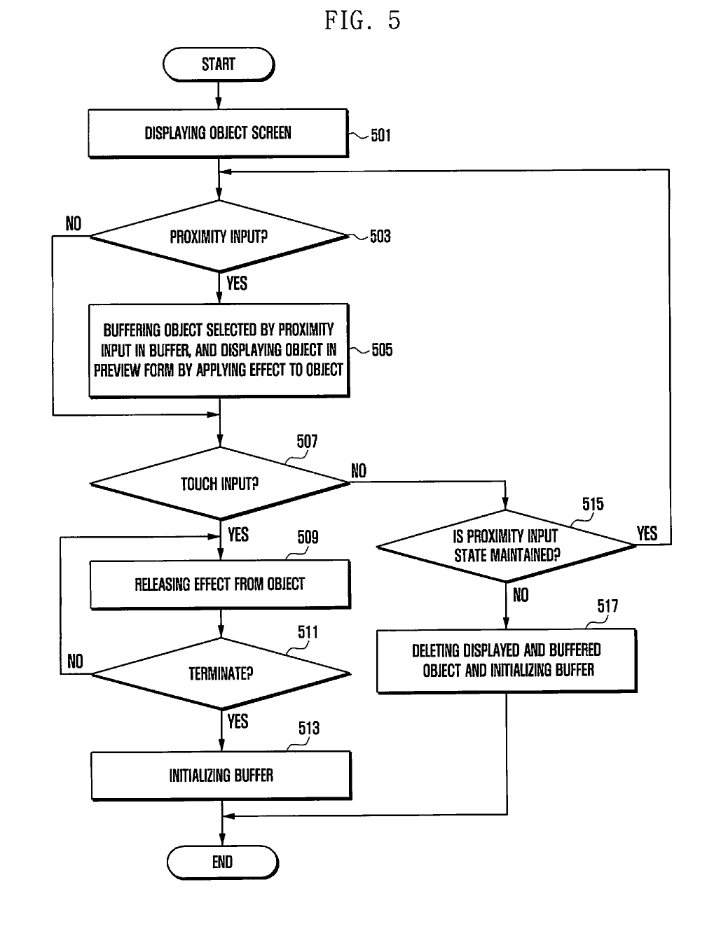

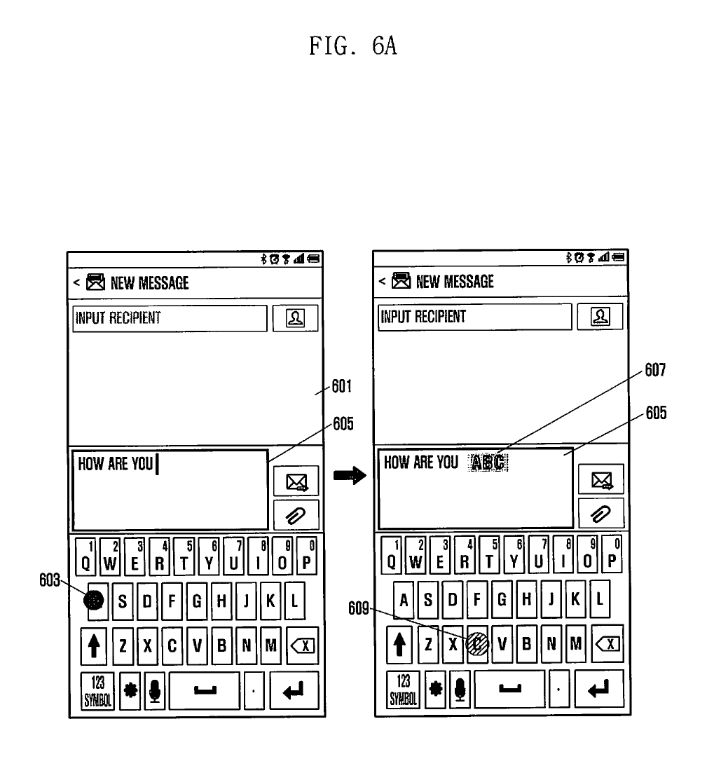

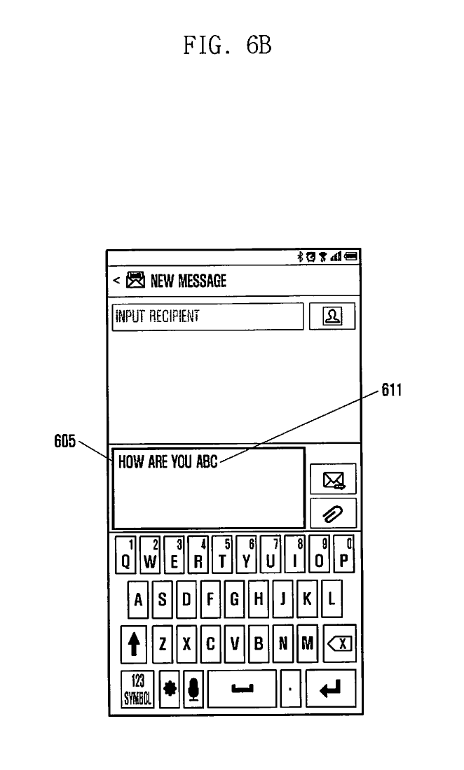

FIG. 5 is a flowchart of a method of of processing a proximity input. FIGS. 6A and 6B are illustrations of processing a proximity input.

Referring to FIGS. 5, 6A, and 6B, the controller 140 is configured to control the display unit 131 to display an object screen in step 501. An object screen is a screen for an executed application, and especially, may include all application execution screens on which characters may be input by using a keypad. The object may be keys of the keypad. Hereinafter, the object screen of the present invention is described on the assumption that the object screen 601 of FIG. 6A is a screen on which a message can be input.

The controller 140 is configured to determine whether the proximity input is detected via the touch panel 132 on the object screen 601 displayed on the display unit 131 in step 503. The proximity input may include a hovering input which means a status in which an input instrument, e.g., a user's finger or an electronic pen, does not touch the touch screen 130 and is spaced at a predetermined distance from the touch screen 130, e.g., located within a predetermined height from a surface of the touch screen 130. When the proximity input is detected, the controller 140 is configured to provide a visual effect, e.g., brightness, color and magnitude, an audible effect, e.g., voice, or a tactile effect, e.g., vibration, in response to the proximity input. Further, when the input instrument is maintained for a predetermined time in the state that it is spaced at the preset distance from the touch screen, the controller 140 is configured to determine the proximity status and detect a positioning coordinate of the input instrument. In an embodiment of the present invention, the input instrument is described on the assumption that it is the user's finger, but the input instrument is not limited thereto.

When the proximity input is detected, the controller 140 is configured to detect a coordinate of a location where the proximity input is detected, and determine that the object located at the coordinate is selected. Then, the controller 140 is configured to buffer the object selected by the proximity input in the buffer, and control the display unit 131 to display the object in a preview form by applying an effect to the object in step 505. The application of the effect is to distinguish the object buffered in the buffer from the existing object actually displayed and/or input.

If the touch input is not detected in step 507 and the proximity input is maintained in step 515 as described below, the controller 140 is configured to repeatedly perform a step of detecting the proximity input, which is performed in step 503, and a step of buffering the object selected by the proximity input in the buffer, which is performed in step 505. That is, the controller 140 is configured to store a plurality of objects in the buffer via the repeated step of selecting, storing, and displaying the plurality of objects which are continuously and/or discontinuously arranged and constitute one screen. Further, the object is selected at the same time when the object is displayed in the preview form. Accordingly, the user can immediately identify whether there is an error of the input object. That is, the selected objects are sequentially stored in the buffer, and an effect is applied to the stored object, so as to display the object.

The controller 140 is configured to determine whether the touch input is detected on the object selected by the proximity input in step 507. When the touch gesture is detected, the controller 140 is configured to detect the touch gesture in step 507, release the effect applied to the object in step 509, and control the display unit 131 to display the object in the same style as the actually displayed object.

Then, the controller 140 is configured to determine whether the display of the object is terminated in step 511. When an input of the termination occurs, the controller 140 is configured to initialize the buffer and terminate a function of the proximity input in step 513.

If the touch input is not detected in step 507, the controller 140 is configured to determine whether the proximity input is maintained in step 515. When the proximity input signal is received from the touch panel 132, the controller 140 is configured to determine that the proximity input state is maintained. If the proximity input signal is not received from the touch panel 132, the controller is configured to determine that the proximity input state is not maintained. When it is determined that the proximity input state is maintained, the controller 140 proceeds to step 503, and is configured to determine whether the proximity input is detected. When it is determined that the proximity input state is not maintained, the controller 140 is configured to delete the object to which the effect is applied, and initialize the buffer in step 517. Finally, the controller 140 is configured to terminate the proximity input function.

For example, when a proximity input 603 is detected on a letter “A” in a keypad displayed on the screen 601 of FIG. 6A, the controller 140 is configured to apply an effect to the letter “A” and display the letter “A” on an input window 605. A process of applying the effect to the key detected by the proximity input and display the key on the input window in the preview form in the keypad may be continuously repeated when the proximity input state is not maintained.

That is, the object “ABC” 607 buffered by repeatedly performing the proximity input may be displayed in the preview form by applying the effect to the object in the input window 605 of FIG. 6A. By applying the effect to the object, the object buffered in the buffer may be distinguished from the existing object displayed and/or actually input. In an embodiment of the present invention, the effect may include a superscript, a subscript, a color, brightness, a pattern, a background color, and a highlight. The character to which the effect is applied is not applied as an actual inputcharacter, but an object buffered in the buffer. In order to apply the input character as the actual inputcharacter, a touch input must be detected on a key (e.g. “C”) 609. When the touch input is detected, the effect applied to the object 611 of FIG. 6B is released from the character, or characters, stored in the buffer, thereby displaying the character stored in the buffer in the form of the actually inputcharacter.

When the touch input is not detected and the proximity input signal is not received, the object to which the effect is applied is deleted from the input window. That is, the object screen 601 of FIG. 6A is displayed.

Although the method and apparatus for processing an input of an electronic device has been described above in connection with the embodiments disclosed in the present specification and drawings, these embodiments are provided merely to describe and facilitate understanding of the present invention, and are not intended to limit the scope of the present invention. Therefore, it should be construed that all modifications or modified forms drawn by the technical idea of the present invention in addition to the embodiments disclosed herein are included in the scope spirit of the present invention as defined by appended claims and their equivalents.

What is claimed is:

1. A method of processing an input of an electronic device, the method comprising:
displaying an object screen;
buffering an object at a position where a proximity input is detected, when the proximity input is detected; and
executing the buffered object and displaying an execution screen when a touch input is detected on the object on which the proximity input occurs.

2. The method of claim 1, wherein buffering the object further comprises:
determining whether a state of the proximity input is maintained if the touch input is not detected on the object where the proximity input is detected; and
initializing the buffered object if the proximity input state is not maintained.

3. The method of claim 2, wherein initializing the buffered object comprises deleting the buffered object if the proximity input is not detected for a predetermined time.

4. The method of claim 1, wherein displaying the execution screen comprises:
displaying at least two object execution windows in a form of multi-windows;
selecting one of the at least two object execution windows displayed in the form of multi-windows; and
adjusting and displaying the selected one of at least two object execution windows of which a size is adapted to the execution screen.

5. The method of claim 4, wherein adjusting and displaying the selected one of the at least two object execution windows of which the size is adapted to the object screen further comprises displaying the selected one of the at least two object execution windows in a form of multi-windows when a touch input is detected on a returning item separately provided to the selected one of at least two object execution windows.

6. The method of claim 5, further comprising:
detecting the proximity input on the selected one of the at least two object execution windows of which a size is adjusted, if the touch input is detected on the returning item;
buffering the object where the proximity input is detected, and deleting an existing buffered object;
detecting the touch input on the object where the proximity input is detected; and
executing and displaying the buffered object collectively.

7. The method of claim 6, further comprising initializing the object if the touch input is not detected on the object on which the proximity input is detected or the proximity input state is not maintained.

8. A method of processing an input of an electronic device, the method comprising:
displaying an object screen;
buffering an object at a position where a proximity input is detected when the proximity input is detected, and displaying the object in a preview form by applying an effect to the object; and
displaying the object after the effect applied to the object is released when a touch input is detected on the object on which the proximity input is detected.

9. The method of claim 8, wherein displaying the object in the preview form further comprises:
determining whether a state of the proximity input is maintained if a touch input is not detected on the object where the proximity input is detected; and
deleting the object displayed in the preview form and initializing the buffered object, if the proximity input state is not maintained.

10. The method of claim 8, wherein the effect comprises at least one of brightness, color, size, and shape.

11. An apparatus for processing an input of an electronic device, the apparatus comprising:
a touch screen configured to display an object screen and detect a proximity input and a touch input;
a buffer configured to buffer an object selected by the proximity input; and
a controller configured to buffer an object, at a position where a proximity input is detected, in a buffer when the proximity input is detected on the object screen displayed on the touch screen, execute the buffered object when a touch input is detected on the object where the proximity input is detected, and display the object execution screen.

12. The apparatus of claim 11, wherein the controller is configured to determine whether a state of the proximity input is maintained if the touch input is not detected on the object where the proximity input is detected, and initialize the buffered object if the proximity input state is not maintained.

13. The apparatus of claim 12, wherein the controller is configured to delete the buffered object if the proximity input is not detected for a predetermined time.

14. The apparatus of claim 11, wherein the controller is configured to display at least two object execution windows in a form of multi-windows on the touch screen, and display a selected one of at least two object execution windows by adjusting a size of the selected one of at least two object execution windows to be adapted to the touch screen when one of the at least two object execution windows is selected.

15. The apparatus of claim 14, wherein the controller is configured to display the selected one of at least two object execution windows that was size adjusted size on the touch screen, when a touch input is detected on a returning item separately provided to the selected one of at least two object execution windows that was size adjusted.

16. The apparatus of claim 15, wherein the controller is configured to detect the proximity input on a selected one of at least two object execution windows that was size adjusted if the touch input is not detected on the returning item, buffer an object located at a position where the proximity input is detected and to delete an existing buffered object, and execute the buffered objects collectively and to display an execution screen.

17. An apparatus for processing an input of an electronic device, the apparatus comprising:
a touch screen is configured to display an object screen and detect a proximity input and a touch input;
a buffer configured to buffer an object selected by the proximity input; and
a controller configured to buffer an object, located at a position where the proximity input is detected, in the buffer and display the object in a preview form by applying an effect to the object, and release the effect applied to the object and display the object when the touch input is detected on the object where the proximity input is detected.

18. The apparatus of claim 17, wherein the controller is configured to delete the object displayed in the preview form if the touch input is not detected on the object where the proximity input is detected, or a proximity input state is not maintained, and initialize the object stored in the buffer.
